(19) United States
(12) Patent Application Publication
(10) Pub. No.: US 2019/0311371 A1
(43) Pub. Date: Oct. 10, 2019

(54) INFORMATION PROCESSING DEVICE AND INFORMATION PROCESSING METHOD

(71) Applicant: SONY CORPORATION, TOKYO (JP)

(72) Inventor: HIROSHI IWANAMI, TOKYO (JP)

(21) Appl. No.: 16/347,096

(22) PCT Filed: Sep. 15, 2017
(86) PCT No.: PCT/JP2017/033576

§ 371 Date: May 2, 2019

(30) Foreign Application Priority Data
Dec. 20, 2016 (JP) 2016-246193

(51) Int. Cl. G06Q 20/42; H04L 29/08

(52) U.S. Cl. CPC G06Q 20/42; H04L 67/20

(57) ABSTRACT

[Object] To provide an information processing device and an information processing method capable of enabling third-party use of an emotion value serving as an index of a person's value to further improve convenience of emotion values. [Solution] An information processing device including: an accumulation unit configured to accumulate, in units of users, emotion values that are indices obtained by converting values of respective objects into numerical values on the basis of interaction between objects; a communication unit configured to perform communication and capable of receiving an emotion value request together with a purpose of use from a user, and returning the user's emotion value to the user; and a control unit configured to control the communication unit to return, when an emotion value request is received together with a purpose of use from a user, the user's emotion value to the user, and transmit, when an emotion value request is received together with a purpose of use from a third party that requests a user's emotion value, to the user that there has been an emotion value request from the third party together with the purpose of use, and transmit the user's emotion value to the third party when consent from the user is received.

### TECHNICAL FIELD

The present disclosure relates to an information processing device and an information processing method.

### BACKGROUND ART

Conventionally, an idea presented by a speaker has been evaluated in a contest (including a pitch organized by a venture capital, and Assertion of Youth) or the like, and investment of a venture capital or the like has been decided in many cases.

For example, Patent Literature 1 below discloses a suggestion evaluation method that, in processing votes of the number of supporters for provided service, notifies an application service provider (ASP) operator even if the number of supporters is small when the proposer is a heavy user, notifies the ASP operator of a proposal about an improvement in current functions on the basis of the number of supporters who are large-volume customers, and notifies the ASP operator of a proposal of a new function on the basis of the number of supporters who are non-large-volume customers and are heavy users.

In addition, Patent Literature 2 below discloses a system that accepts votes sent from any users in regard to an idea proposed on a Web page, and enables past ideas or the like of the proposer of the idea to be seen.

### CITATION LIST

### Patent Literature

Patent Literature 1: JP 2004-086346A

Patent Literature 2: JP 2002-163439A

### DISCLOSURE OF INVENTION

### Technical Problem

However, in addition to evaluating the merits and demerits of an idea or a plan presented by a speaker, in adopting the speaker's idea, whether the person is a credible person is also an important element. In addition, as well as in a contest, also in a job interview for example, the person's personality such as personal credibility is information that the recruiter absolutely wants to know, and the party (user) who receives evaluation also wants to make an appeal for his/her own credibility.

Hence, the present disclosure provides an information processing device and an information processing method capable of enabling third-party use of an emotion value serving as an index of a person's value to further improve convenience of emotion values.

### Solution to Problem

According to the present disclosure, there is proposed an information processing device including: an accumulation unit configured to accumulate, in units of users, emotion values that are indices obtained by converting values of respective objects into numerical values on the basis of interaction between objects; a communication unit configured to perform communication and capable of receiving an emotion value request together with a purpose of use from a user, and returning the user's emotion value to the user; and a control unit configured to control the communication unit to return, when an emotion value request is received together with a purpose of use from a user, the user's emotion value to the user, and transmit, when an emotion value request is received together with a purpose of use from a third party that requests a user's emotion value, to the user that there has been an emotion value request from the third party together with the purpose of use, and transmit the user's emotion value to the third party when consent from the user is received.

According to the present disclosure, there is proposed an information processing method including, by a processor: accumulating, in units of users in an accumulation unit, emotion values that are indices obtained by converting values of respective objects into numerical values on the basis of interaction between objects; and controlling a communication unit to return, when an emotion value request is received together with a purpose of use from a user via the communication unit, the user's emotion value to the user, and transmit, when the communication unit receives an emotion value request together with a purpose of use from a third party that requests a user's emotion value, to the user that there has been an emotion value request from the third party together with the purpose of use, and transmit the user's emotion value to the third party when the communication unit receives consent from the user.

### Advantageous Effects of Invention

According to the present disclosure as described above, it is possible to enable third-party use of an emotion value serving as an index of a person's value to further improve convenience of emotion values.

Note that the effects described above are not necessarily limitative. With or in the place of the above effects, there may be achieved any one of the effects described in this specification or other effects that may be grasped from this specification.

### BRIEF DESCRIPTION OF DRAWINGS

FIG. 1 is a diagram for describing an overview of an information processing system according to an embodiment of the present disclosure.

FIG. 2 illustrates an example of an overall configuration of the information processing system according to the present embodiment.

FIG. 3 is a block diagram illustrating an example of a configuration of an emotion server according to the present embodiment.

FIG. 4 is a diagram for describing a case where there is a disclosure request from a user him/herself in a first example.

FIG. 5 is a diagram for describing a case where there is a disclosure request from a third party in the first example.

FIG. 6 is a flowchart illustrating disclosure control processing of the emotion server according to the first example.

FIG. 7 is a diagram for describing a case where there is a disclosure request from a user him/herself in a second example.

FIG. 8 is a diagram for describing a case where there is a disclosure request from a third party in the second example.

FIG. 9 is a flowchart illustrating disclosure control processing of the emotion server according to the second example.

FIG. 10 illustrates an example of a disclosure cost billing screen for a user according to the second example.

FIG. 11 illustrates an example of a disclosure cost billing screen for an organizer according to the second example.

FIG. 12 is a diagram for describing a case where there is a disclosure request from an organizer in a third example.

FIG. 13 is a flowchart illustrating disclosure control processing of the emotion server according to the third example.

FIG. 14 illustrates an example of a screen for checking whether or not a user bears cost for a disclosure request from an organizer according to the third example.

FIG. 15 is a diagram for describing a case of paying emotion value disclosure cost by an emotion value of a user him/herself according to a fourth example.

FIG. 16 illustrates an example of an emotion value certificate according to the present embodiment.

### MODE(S) FOR CARRYING OUT THE INVENTION

Hereinafter, (a) preferred embodiment(s) of the present disclosure will be described in detail with reference to the appended drawings. Note that, in this specification and the appended drawings, structural elements that have substantially the same function and structure are denoted with the same reference numerals, and repeated explanation of these structural elements is omitted.

In addition, description is given in the following order.

1. Overview of information processing system according to embodiment of present disclosure

2. Configuration
2-1. Overall configuration
2-2. Configuration of emotion server 2

3. Examples
3-1. First example
3-2. Second example
3-3. Third example
3-4. Fourth example

4. Conclusion

### 1. OVERVIEW OF INFORMATION PROCESSING SYSTEM ACCORDING TO EMBODIMENT OF PRESENT DISCLOSURE

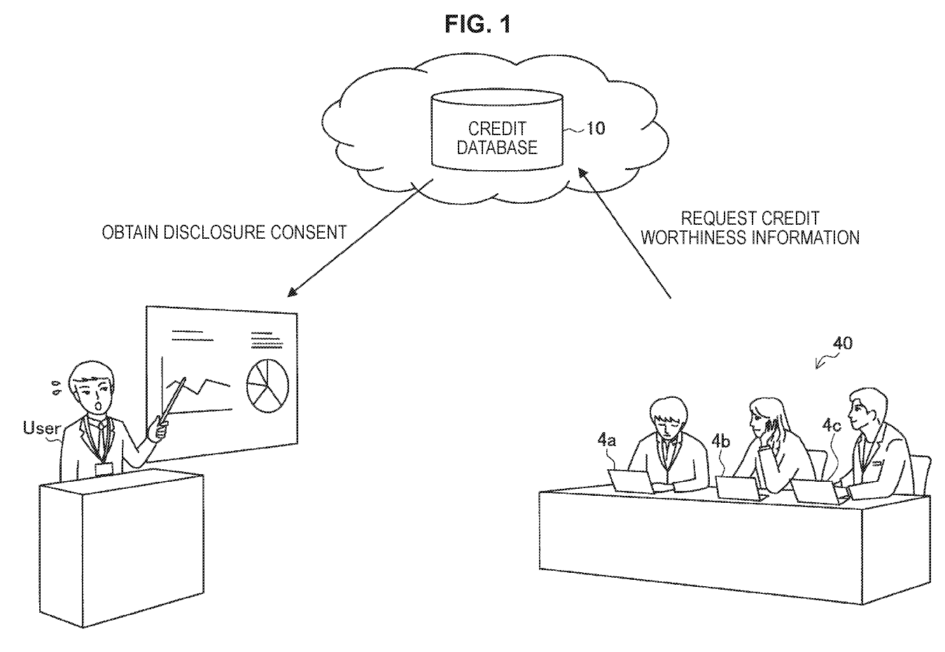

FIG. 1 is a diagram for describing an overview of an information processing system according to an embodiment of the present disclosure. As illustrated in FIG. 1, the information processing system according to the present embodiment makes it possible to see credit worthiness information (an example of an emotion value) of a user who is a presenter, from a credit database 10, in response to a request from an organizer 40 (an evaluator), thereby enabling third-party use of an emotion value, and improving convenience of emotion values.

A request for disclosure of credit worthiness information is made to the credit database 10 on a network from an organizer terminal 4a, for example. In the case where disclosure consent is obtained for the user, the credit database 10 transmits the user's credit worthiness information to the organizer terminal 4a.

Here, in the present embodiment, personality and credibility of a person are converted into numerical values (in this specification, referred to as “emotion value”) on the basis of the person's daily acts (interaction between objects including things), and are accumulated in the credit database 10 (an example of an emotion value database 22). Then, in a contest such as a venture pitch, they are disclosed in consideration of security in response to a request from the organizer side; thus, better evaluation can be obtained.

In addition, in idea evaluation in a venture pitch or the like, in the case where quality of a presentation on the day is not so good, or in the case where past achievements seem not to be understood by the evaluator so much, the user side may also want to disclose his/her own credit information (emotion value) to be trusted more by the partner.

Particularly in a scene where a severe venture investment judgment is made, disclosure of credit information (emotion value) is useful. Note that disclosing credit information (emotion value) to a third party can be said to be a high-risk act, because one's own credibility is made to be known to a third party but there is a concern for abuse. Therefore, disclosure processing is performed in consideration of security (e.g., the user's consent is obtained in the case where there is a disclosure request from a third party).

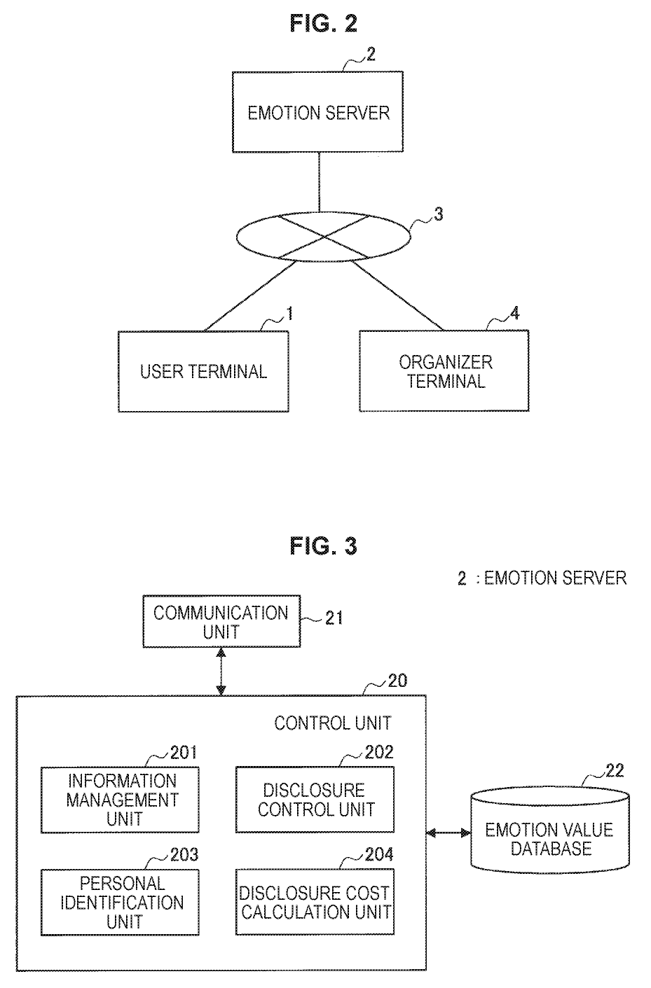

The information processing system according to an embodiment of the present disclosure has been described above. Next, a configuration of the information processing system according to the present embodiment will be described with reference to FIG. 2 to FIG. 3.

### 2. CONFIGURATION

<2-1. Overall Configuration>

FIG. 2 illustrates an example of an overall configuration of the information processing system according to the present embodiment. As illustrated in FIG. 2, the information processing system according to the present embodiment includes a user terminal 1, an emotion server 2, and an organizer terminal 4. The user terminal 1, the emotion server 2, and the organizer terminal 4 can be connected via a network 3 to transmit and receive data.

The emotion server 2 performs control to accumulate emotion values, which are indices obtained by converting values of respective objects into numerical values on the basis of interaction between objects including people and things, in units of users (the emotion value database 22), and disclose an emotion value in response to a request from the user or a third party (an organizer of a contest or the like).

The user terminal 1 and the organizer terminal 4 are information processing terminals such as a smartphone, a mobile terminal, a head mounted display (HMD), a wearable terminal, and a PC, and each display information received from the emotion server 2 on a display unit, and transmit operation input information input by the user or the organizer to the emotion server 2.

<2-2. Configuration of emotion server 2>

FIG. 3 is a block diagram illustrating an example of a configuration of the emotion server 2 according to the present embodiment. As illustrated in FIG. 3, the emotion server 2 includes a control unit 20, a communication unit 21, and the emotion value database 22.

The control unit 20 functions as an arithmetic processing device and a control device, and controls the overall operation of the emotion server 2 in accordance with a variety of programs. The control unit 20 is implemented, for example, by an electronic circuit such as a central processing unit (CPU) and a microprocessor. In addition, the control unit 20 may include a read only memory (ROM) that stores a program, an operation parameter and the like to be used, and a random access memory (RAM) that temporarily stores a parameter and the like varying as appropriate.

In addition, the control unit 20 according to the present embodiment also functions as an information management unit 201, a disclosure control unit 202, a personal identification unit 203, and a disclosure cost calculation unit 204.

The information management unit 201 performs data management such as registration, update, and deletion of emotion values accumulated in the emotion value database 22.

The disclosure control unit 202 performs predetermined disclosure control in response to a disclosure request. For example, when a request for an emotion value of a user him/herself is received together with a purpose of use from the user, the disclosure control unit 202 performs control to return the user's emotion value to the user. In addition, in the case where an emotion value request is received together with a purpose of use from a third party that requests the user's emotion value, the disclosure control unit 202 performs control to transmit to the user that there has been an emotion value request from the third party together with the purpose of use, and performs control to transmit the user's emotion value to the third party in the case where approval from the user is received. Specific disclosure control is specifically described in examples described later.

The personal identification unit 203 performs personal identification of a user or an organizer to prevent spoofing. For example, personal identification may be performed using a predetermined ID (a secret number, a user name, etc.).

The disclosure cost calculation unit 204 calculates cost for disclosure of an emotion value.

(Communication Unit 21)

The communication unit 21 connects to the network 3 in a wired or wireless manner, and transmits and receives data to and from the user terminal 1 and the organizer terminal 4 via the network 3. For example, the communication unit 21 connects by communication to the network 3 by a wired/wireless local area network (LAN), wireless fidelity (Wi-Fi; registered trademark), or the like. The communication unit 21 according to the present embodiment receives a request for disclosure of the user's emotion value from the user terminal 1 or the organizer terminal 4, and transmits the user's emotion value to the organizer terminal 4 in response to the request.

(Emotion Value Database 22)

The emotion value database 22 accumulates emotion values for each user. An emotion value is a new index obtained by defining all people and things as objects, and then converting values of respective objects into numerical values on the basis of interaction between objects. The emotion value may be expressed by a multidimensional vector, and the vector may be reduced in dimension or used being put into a simple scalar value for easy handling. In addition, a reduction in device size and progress of battery technologies and network technologies in recent years have brought about the era of Internet of Things (IoT) that connects things to each other, so that interaction between objects can be sensed and an emotion value can be calculated without distinction between things and people. Assumed as interaction between objects are, for example, an act performed on others by the user (an act of kindness, an act of keeping good manners, communication on a social network, etc.), and an act performed on things (a purchase act, an act of taking good care of things, such as cleaning or storage, driving operations, etc.).

In addition, the emotion value database 22 can be stored in a storage unit. The storage unit may include a read only memory (ROM) that stores programs, operation parameters, or the like used by the control unit 20, and a random access memory (RAM) that temporarily stores parameters that change as appropriate or the like.

### 3. EXAMPLES

Next, the information processing system according to the present embodiment will be specifically described using a plurality of examples.

### 3-1. First Example

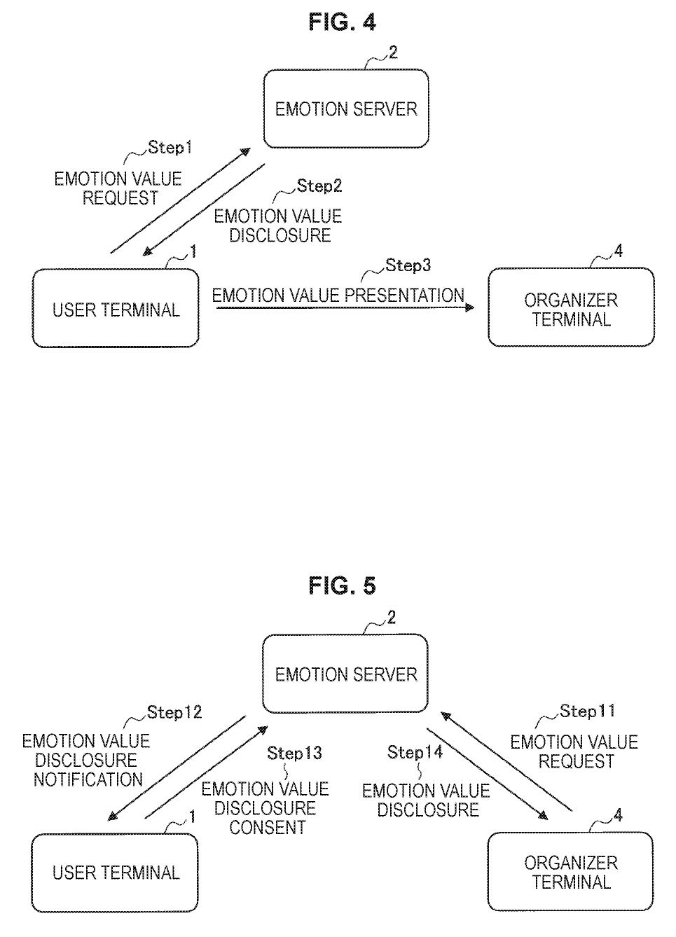

First, a first example is described with reference to FIG. 4 to FIG. 6.

FIG. 4 is a diagram for describing a case where there is a disclosure request from a user him/herself in the first example. For example, in a venture pitch or the like, in the case where the user wants to somehow receive venture investment even though quality of a presentation on the day is not so good, for example, the user may want to disclose his/her own emotion value to an organizer (a third party) to be trusted by the partner.

In this case, as illustrated in FIG. 4, the user makes a request for an emotion value from the user terminal 1 to the emotion server 2 (Step 1), and the user's emotion value is disclosed from the emotion server 2 (Step 2).

Then, the user presents the emotion value from the user terminal 1 to the organizer terminal 4 (Step 3). Presentation to the organizer may be verbal or written, as well as data transmission to the organizer terminal 4.

In this manner, in the first example, the user him/herself can request disclosure of his/her own emotion value, and disclose the emotion value to a third party.

On the other hand, a case where a third party requests disclosure of a user's emotion value is also assumed. FIG. 5 is a diagram for describing a case where there is a disclosure request from a third party in the first example. For example, in the case where who will participate in a venture pitch is obvious, the organizer side of the venture pitch can know an emotion value of the presenter (user) in advance.

In this case, as illustrated in FIG. 5, when the organizer makes a request for an emotion value from the organizer terminal 4 to the emotion server 2 (Step 11), the emotion server 2 makes emotion value disclosure notification (notifies that disclosure is requested from a third party) to the user terminal 1 (Step 12).

Then, when the user consents to disclosure in response to the disclosure notification (Step 13), the emotion server 2 discloses an emotion value to the organizer terminal 4 (Step 14).

In this manner, in the case where a third party requests disclosure of an emotion value, in consideration of security, the user him/herself is notified that there has been a disclosure request, and the emotion value is disclosed to the third party in the case where consent is obtained.

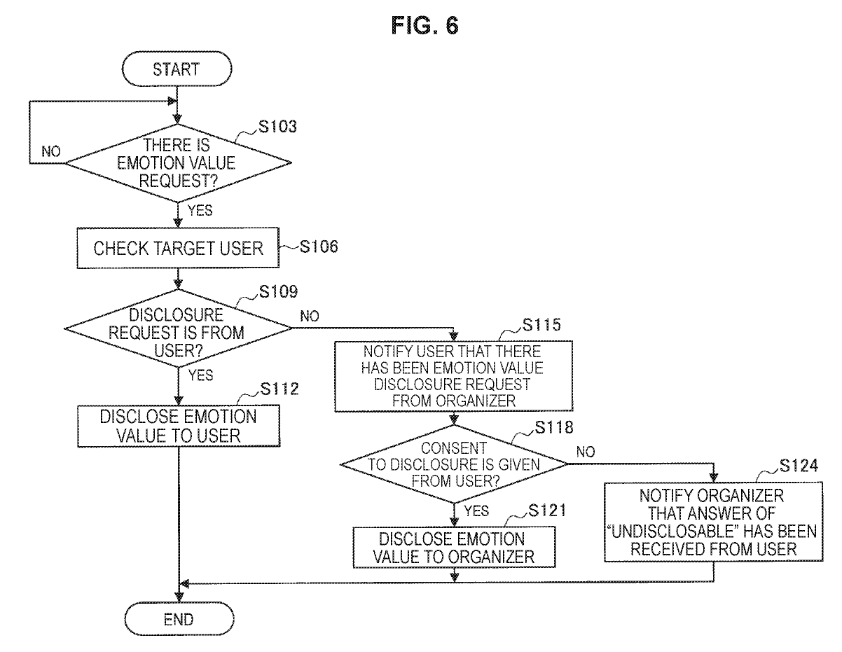

Operation processing in the first example described above is specifically described with reference to FIG. 6. FIG. 6 is a flowchart illustrating disclosure control processing of the emotion server 2 according to the first example.

As illustrated in FIG. 6, first, in the emotion server 2, in the case where there is an emotion value request (step S103/Yes), the information management unit 201 checks whether or not there is the target user's emotion value information in the emotion value database 22 (step S106). The emotion value request includes a purpose of use of the emotion value. For example, assumed are the user's purpose of use that “I want to receive investment at the venture pitch of XX”, and a third party (organizer)'s purpose of use that “the target person is a presenter of a venture pitch, and I want to check emotion value disclosure of the target person for investment judgment”.

Next, in the case where a disclosure request is from the user him/herself (step S109/Yes), the disclosure control unit 202 extracts the user's emotion value from the emotion value database 22, and discloses the emotion value to the user (transmits emotion value information to the user terminal 1) (step S112). At this time, the personal identification unit 203 can perform personal identification.

On the other hand, in the case where the disclosure request is not from the user (step S109/No), the disclosure control unit 202 notifies the user that there has been an emotion value disclosure request from a third party (here, “an organizer of a venture pitch”), together with a reason (purpose of use) (step S115). The user checks the notification from the emotion server 2 on the user terminal 1, and returns disclosability of an emotion value to the emotion server 2.

Then, in the case where consent to disclosure is given from the user (step S118/Yes), the disclosure control unit 202 performs control to disclose an emotion value to the organizer (step S121). Specifically, the disclosure control unit 202 transmits requested emotion value information of the user to the organizer terminal 4.

On the other hand, in the case where consent to disclosure is not given from the user (step S118/No), the disclosure control unit 202 notifies the organizer that an answer of “undisclosable” has been received from the user (consent has not been obtained) (step S124).

In this manner, in the first example, control is performed to return an emotion value if there is a request from the user, and if there is a request from the organizer, return an emotion value to the organizer after obtaining the user's consent; thus, third-party use of an emotion value is achieved.

### 3-2. Second Example

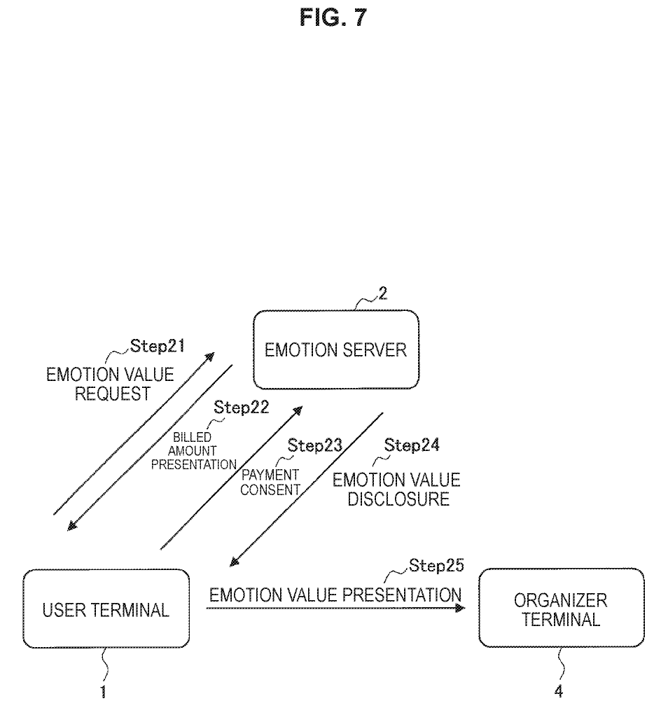

First, a second example is described with reference to FIG. 7 to FIG. 11. Disclosure of an emotion value (credit information) requires cost for collection of emotion values (i.e., collection of interaction and calculation of emotion values), maintenance management of emotion values, security measures (prevention of unauthorized access), disclosure processing burden, and the like; hence, the present example is based on a premise that cost occurs in performing disclosure.

FIG. 7 is a diagram for describing a case where there is a disclosure request from a user him/herself in the second example. As in the first example, for example, in a venture pitch or the like, in the case where the user wants to somehow receive venture investment even though quality of a presentation on the day is not so good, for example, the user may want to disclose his/her own emotion value to an organizer (a third party) to be trusted by the partner.

In this case, as illustrated in FIG. 7, when the user makes a request for an emotion value from the user terminal 1 to the emotion server 2 (Step 21), a billed amount of cost for emotion value disclosure is presented from the emotion server 2 (Step 22). The cost for emotion value disclosure can be calculated by the disclosure cost calculation unit 204 of the emotion server 2.

Then, when the user consents to payment (Step 23), the emotion server 2 discloses the user's emotion value (Step 24).

Then, the user presents the emotion value to the organizer terminal 4 from the user terminal 1 (Step 25).

In this manner, in the first example, in the case where the user him/herself requests disclosure of his/her own emotion value, disclosure of the emotion value can be received by consenting to payment of disclosure cost.

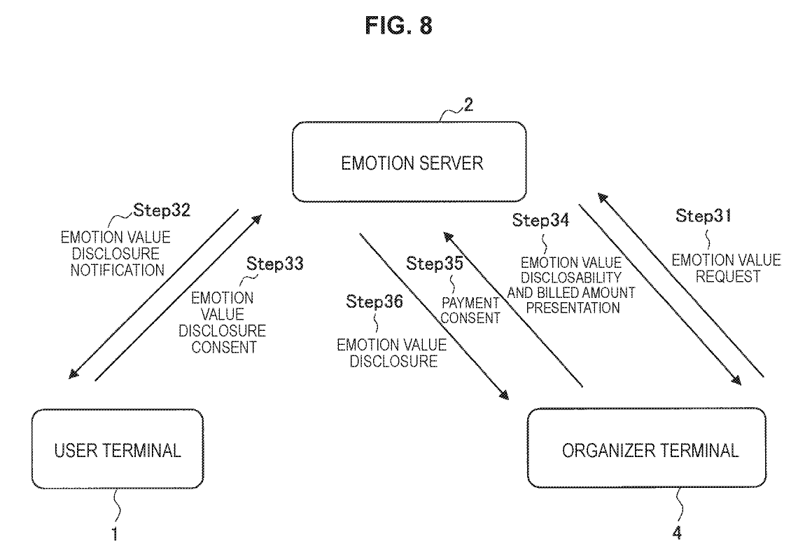

On the other hand, a case where a third party requests disclosure of a user's emotion value is also assumed. FIG. 8 is a diagram for describing a case where there is a disclosure request from a third party in the second example. For example, in the case where who will participate in a venture pitch is obvious, the organizer side of the venture pitch can know an emotion value of the presenter (user) in advance.

In this case, as illustrated in FIG. 8, when the organizer makes a request for an emotion value from the organizer terminal 4 to the emotion server 2 (Step 31), the emotion server 2 makes emotion value disclosure notification (notifies that disclosure is requested from a third party) to the user terminal 1 (Step 32).

Then, when the user consents to disclosure in response to the disclosure notification (Step 33), the emotion server 2 notifies the organizer terminal 4 whether or not an emotion value is disclosable (consented to/not consented to), and presents a billed amount of cost for disclosure (Step 34).

Next, when the organizer consents to payment (Step 35), the emotion server 2 discloses the user's emotion value to the organizer (Step 36).

In this manner, in the second example, in the case where a third party requests disclosure of an emotion value, the third party is billed for disclosure cost.

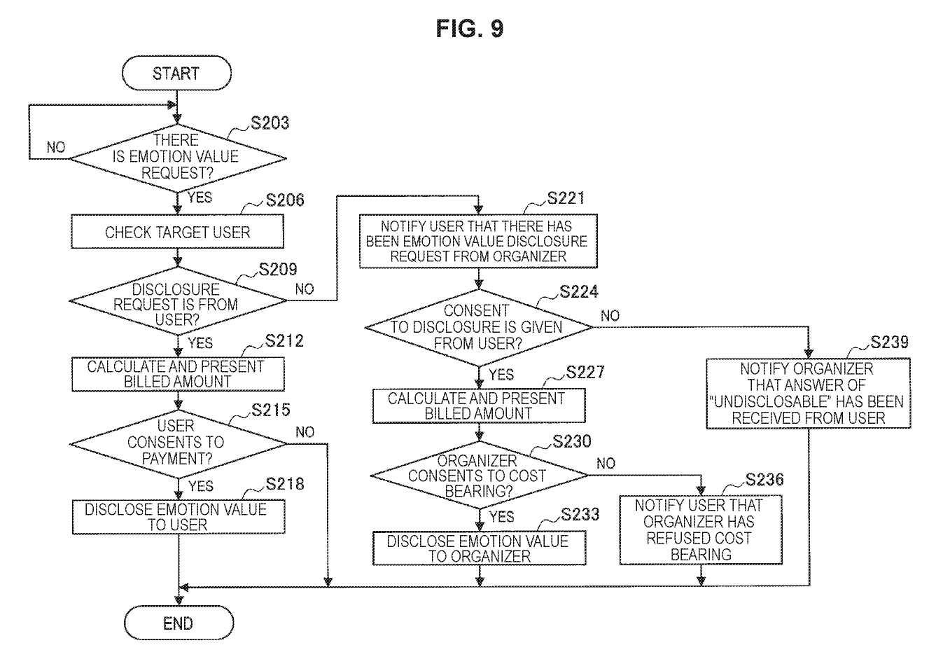

Operation processing in the second example described above is specifically described with reference to FIG. 9. FIG. 9 is a flowchart illustrating disclosure control processing of the emotion server 2 according to the second example.

As illustrated in FIG. 9, first, in the emotion server 2, in the case where there is an emotion value request (step S203/Yes), the information management unit 201 checks whether or not there is the target user's emotion value information in the emotion value database 22 (step S206). The emotion value request includes a purpose of use of the emotion value.

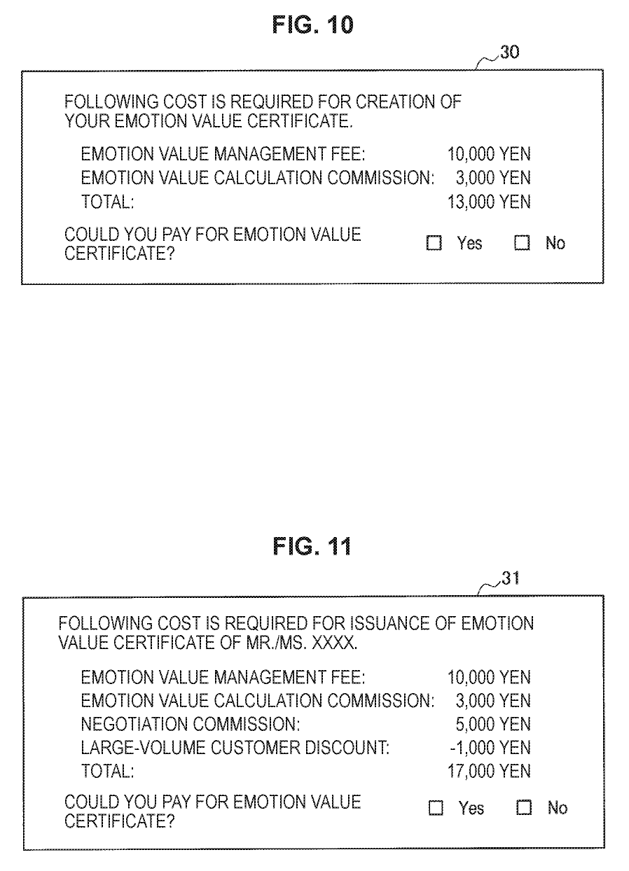

Next, in the case where a disclosure request is from the user him/herself (step S209/Yes), the disclosure cost calculation unit 204 calculates a billed amount of disclosure cost, and presents the billed amount to the user (step S212). Here, FIG. 10 illustrates an example of a disclosure cost billing screen. As illustrated in FIG. 10, a billing screen 30 is displayed on the user terminal 1, and the user checks a billed amount and then selects “Yes” in the case of consenting to payment. Note that the billed amount illustrated in FIG. 10 is an example, and the present example is not limited to this.

Then, in the case where the user consents to payment (step S215/Yes), the disclosure control unit 202 extracts the user's emotion value from the emotion value database 22, and discloses the emotion value to the user (transmits emotion value information to the user terminal 1) (step S218).

On the other hand, in the case where the disclosure request is not from the user (step S209/No), the disclosure control unit 202 notifies the user that there has been an emotion value disclosure request from a third party (here, “an organizer of a venture pitch”), together with a reason (purpose of use) (step S221). The user checks the notification from the emotion server 2 on the user terminal 1, and returns disclosability of an emotion value to the emotion server 2.

Next, in the case where consent to disclosure is given from the user (step S224/Yes), the disclosure cost calculation unit 204 calculates a billed amount of disclosure cost, and presents the billed amount to the organizer (step S227). Here, FIG. 11 illustrates an example of a disclosure cost billing screen. As illustrated in FIG. 11, a billing screen 31 is displayed on the user terminal 1, and the organizer checks the billed amount and then selects “Yes” in the case of consenting to payment. Note that the billed amount illustrated in FIG. 11 is an example, and the present example is not limited to this. In addition, disclosure cost in the case where there is a request from the user and in the case where there is a request from the organizer may be set to different amounts, as illustrated in FIG. 10 and FIG. 11. For example, for the system side, a case where the user him/herself acquires an emotion value certificate and presents the certificate to the organizer requires a smaller number of steps; in the case where there is a request for disclosure from the organizer, since an important emotion value will be disclosed to a third party, a step for obtaining consent from the user is needed, which is troublesome. Therefore, cost may be made higher in the case where the organizer side requests an emotion value than in the case where the user him/herself requests an emotion value. The organizer consents to payment in the case of wanting information regarding personality of the target person in exchange for some cost.

Then, in the case where the organizer consents to payment (step S230/Yes), the disclosure control unit 202 performs control to disclose an emotion value to the organizer (step S233).

On the other hand, in the case where the organizer does not consent to payment (step S230/No), the disclosure control unit 202 notifies the user that the organizer has refused cost bearing (step S236).

In addition, in the case where consent to disclosure is not given from the user in step S224 above (step S224/No), the disclosure control unit 202 notifies the organizer that an answer of “undisclosable” has been received from the user (consent has not been obtained) (step S239).

In this manner, in the second example, payment of disclosure cost is added to emotion value disclosure conditions.

### 3-3. Third Example

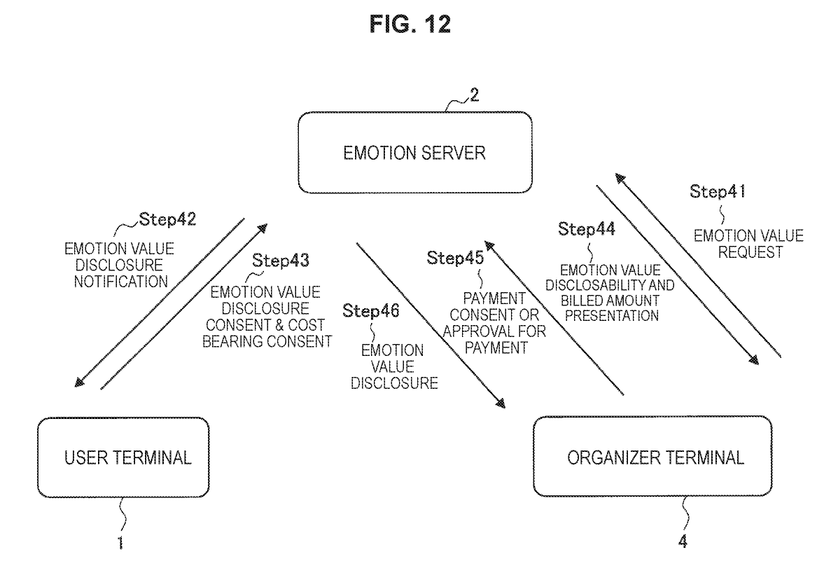

First, a third example is described with reference to FIG. 12 to FIG. 15. The present example describes a case where the user side bears disclosure cost of an emotion value requested by the organizer side.

FIG. 12 is a diagram for describing a case where there is a disclosure request from the organizer in the third example.

As illustrated in FIG. 12, when the organizer makes a request for an emotion value from the organizer terminal 4 to the emotion server 2 (Step 41), the emotion server 2 makes emotion value disclosure notification (notifies that disclosure is requested from a third party) to the user terminal 1 (Step 32). At this time, the emotion server 2 asks the user whether or not to consent to cost bearing. In the case of wanting to raise his/her own trustworthiness as much as possible in a venture pitch or the like, the user may feel like taking over cost bearing when disclosure of his/her own emotion value is requested by the organizer side.

Then, when the user consents to disclosure and consents to cost bearing in response to the disclosure notification (Step 43), the emotion server 2 notifies the organizer terminal 4 whether or not an emotion value is disclosable (consented to/not consented to), and presents a billed amount of cost for disclosure (Step 44). At this time, in the case where the user consents to cost bearing for an emotion value, the emotion server 2 sets an amount of cost to zero, and notifies the organizer terminal 4 of the amount together with notification that the user bears cost.

Next, when the organizer consents to payment or approves bearing by the user (Step 45), the emotion server 2 discloses the user's emotion value to the organizer (Step 46).

In this manner, in the third example, the user can bear disclosure cost in the case where a third party requests disclosure of an emotion value.

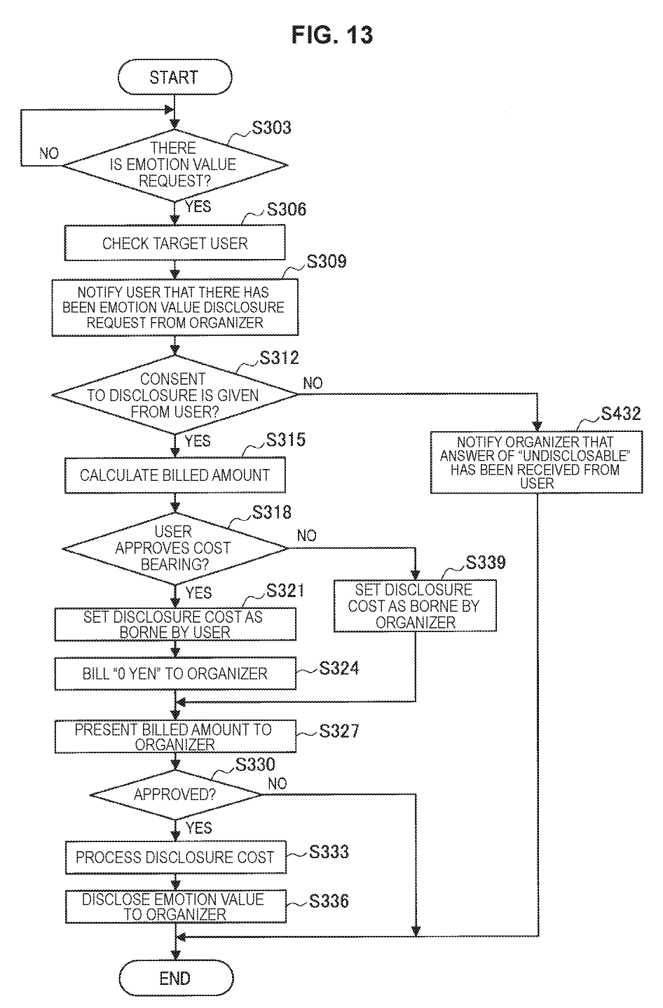

Operation processing in the third example described above is specifically described with reference to FIG. 13. FIG. 13 is a flowchart illustrating disclosure control processing of the emotion server 2 according to the third example. The present example describes a case where there is a disclosure request from the organizer side.

As illustrated in FIG. 13, first, in the emotion server 2, in the case where there is an emotion value request (from the organizer side) (step S303/Yes), the information management unit 201 checks whether or not there is the target user's emotion value information in the emotion value database 22 (step S306). The emotion value request includes a purpose of use of the emotion value.

Next, the disclosure control unit 202 notifies the user that there has been an emotion value disclosure request from a third party (here, “an organizer of a venture pitch”), together with a reason (purpose of use) (step S309). The user checks the notification from the emotion server 2 on the user terminal 1, and returns disclosability of an emotion value to the emotion server 2.

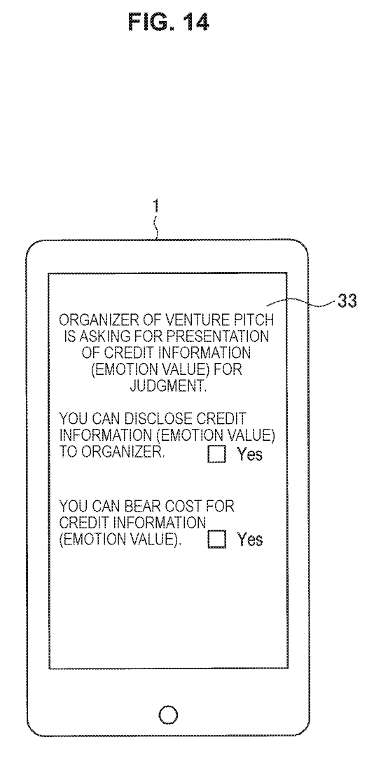

Then, in the case where consent to disclosure is given from the user (step S312/Yes), the disclosure cost calculation unit 204 calculates a billed amount of disclosure cost, and presents the billed amount to the user (step S315). Here, FIG. 14 illustrates an example of a screen for checking whether or not a user bears cost for a disclosure request from an organizer. As illustrated in FIG. 14, on a checking screen 33 displayed on a display unit of the user terminal 1, a screen for inputting disclosability of an emotion value and whether or not cost is bearable in disclosure is displayed. The user puts a check in the corresponding “Yes” in the case of consenting to disclosure, and puts a check in the corresponding “Yes” in the case of further bearing cost. Note that as an example here, the user is notified of disclosability and whether or not cost is bearable at the same time.

Next, in the case where the user approves cost bearing (step S318/Yes), the disclosure cost calculation unit 204 of the emotion server 2 sets disclosure cost as borne by the user (step S321), and sets an amount billed to the organizer to “0 yen” (step S324).

On the other hand, in the case where the user does not approve cost bearing (step S318/No), the disclosure cost calculation unit 204 of the emotion server 2 sets disclosure cost as borne by the organizer (step S339).

Next, the disclosure control unit 202 of the emotion server 2 presents the billed amount to the organizer (step S327). At this time, in the case where the user approves cost bearing, the amount billed to the organizer is “0 yen”.

Then, in the case where the organizer approves payment of the billed amount (or cost bearing by the user) (step S330/Yes), the emotion server 2 performs processing of disclosure cost payment (step S333), and the disclosure control unit 202 extracts the user's emotion value from the emotion value database 22 and discloses the emotion value to the organizer (step S336).

On the other hand, in the case where the organizer does not approve payment (step S330/No), an emotion value is not disclosed.

In addition, in the case where consent to disclosure is not given from the user in step S312 above (step S312/No), the disclosure control unit 202 notifies the organizer that an answer of “undisclosable” has been received from the user (consent has not been obtained) (step S432).

In this manner, in the third example, the user can bear cost for an emotion value disclosure request from the organizer.

### 3-4. Fourth Example

First, a fourth example is described. In the present example, a user can pay emotion value disclosure cost by his/her own emotion value.

That is, in the above-described first to third examples, the emotion server 2 presents, in presenting emotion value disclosure cost to the user, an option of paying cost by an emotion value of the user him/herself as an option.

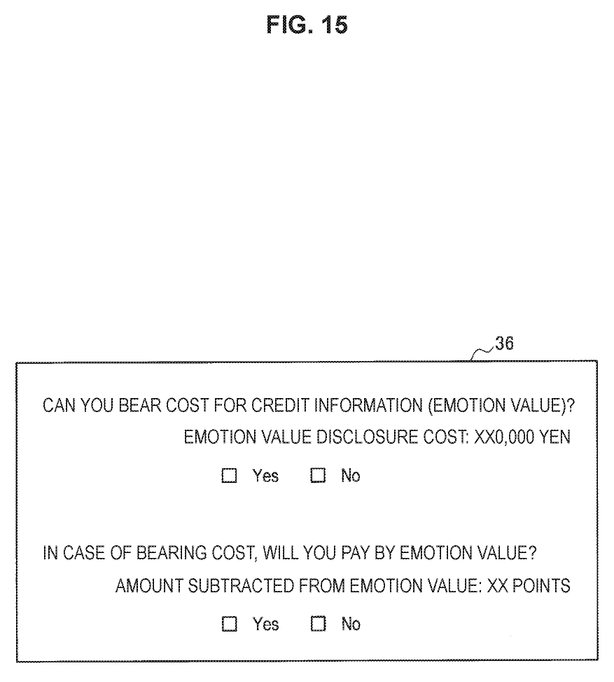

Here, FIG. 15 shows a diagram for describing a case of paying emotion value disclosure cost by an emotion value of the user him/herself. As illustrated in FIG. 15, a billing screen 36 showing a billed amount of disclosure cost includes, a screen on which payment by an emotion value can be selected, in addition to whether or not disclosure cost is payable. In FIG. 15, an amount subtracted from an emotion value in the case of payment by an emotion value is displayed as points. Note that the billing screen 36 is an example; as well as the example illustrated in FIG. 15, only points subtracted from the emotion value may be displayed without presenting an amount of disclosure cost (fee), or only an option of whether or not to pay by an emotion value may be displayed without presenting a subtracted amount.

In the case of paying disclosure cost by his/her own emotion value, the user puts a check in “Yes” of “Will you pay cost by an emotion value?”. In this case, in payment processing, the emotion server 2 subtracts points corresponding to payment from the user's emotion value accumulated in the emotion value database 22.

As described above, in the fourth example, when the user bears emotion value disclosure cost in the above-described first to third examples, paying by an emotion value of the user him/herself can be selected as an option.

(Emotion Value Certificate)

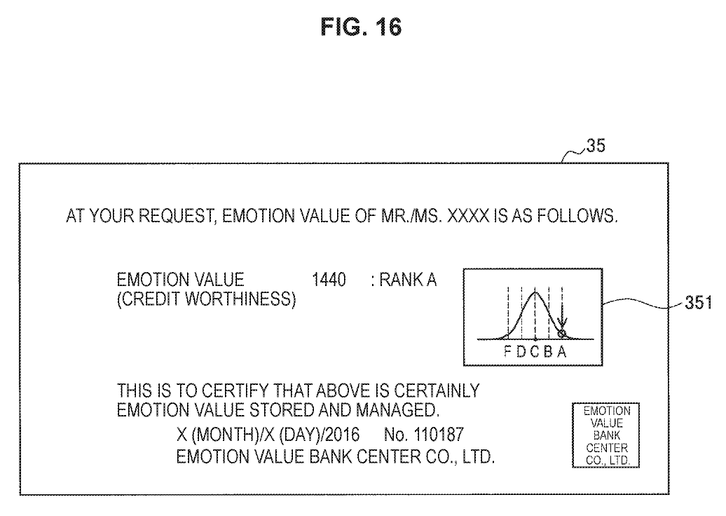

Lastly, an example of an emotion value certificate according to an embodiment of the present disclosure, common to the above first to fourth examples, is described with reference to FIG. 16. FIG. 16 illustrates an example of an emotion value certificate according to the present embodiment.

In the example illustrated in FIG. 16, a presentation example of a user's emotion value disclosed from the emotion server 2 in the case where the organizer side requests disclosure of the user's emotion value is illustrated. As illustrated in FIG. 16, a value of the user's emotion value (credit worthiness) is displayed on a certificate screen 35. In addition, a rank based on a value of the emotion value can also be displayed to show relative evaluation of the emotion value. A rank screen 351 shows around where the rank of the user's emotion value is located among emotion value ranks of all users. This enables the organizer to grasp the user's emotion value.

### 4. CONCLUSION

As described above, the information processing system according to the embodiment of the present disclosure makes it possible to enable third-party use of an emotion value serving as an index of a person's value to further improve convenience of emotion values.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

For example, a computer program for causing hardware such as a CPU, ROM, and RAM built in the user terminal 1, the emotion server 2, or the organizer terminal 4 described above to exhibit functions of the user terminal 1, the emotion server 2, or the organizer terminal 4 can also be produced. Furthermore, a computer-readable storage medium in which the computer program is stored is also provided.

Further, the effects described in this specification are merely illustrative or exemplified effects, and are not limitative. That is, with or in the place of the above effects, the technology according to the present disclosure may achieve other effects that are clear to those skilled in the art from the description of this specification.

Additionally, the present technology may also be configured as below.

(1)

An information processing device including:

an accumulation unit configured to accumulate, in units of users, emotion values that are indices obtained by converting values of respective objects into numerical values on the basis of interaction between objects;

a communication unit configured to perform communication and capable of receiving an emotion value request together with a purpose of use from a user, and returning the user's emotion value to the user; and

a control unit configured to control the communication unit to

return, when an emotion value request is received together with a purpose of use from a user, the user's emotion value to the user, and

transmit, when an emotion value request is received together with a purpose of use from a third party that requests a user's emotion value, to the user that there has been an emotion value request from the third party together with the purpose of use, and transmit the user's emotion value to the third party when consent from the user is received.

(2)

The information processing device according to (1), in which

the control unit controls the communication unit to

transmit, when an emotion value request is received together with a purpose of use from a user, cost billing as an emotion value disclosure requirement to the user, and

return, when information indicating consent to cost payment is received from the user, an emotion value to the user after processing of the payment is completed.

(3)

The information processing device according to (1), in which

the control unit controls the communication unit to

transmit, when an emotion value request is received together with a purpose of use from a third party that requests a user's emotion value, to the user that there has been an emotion value request from the third party together with the purpose of use,

transmit, when information indicating consent from the user is received, cost billing as an emotion value disclosure requirement to the third party, and

return, when information indicating consent to cost payment is received from the third party, an emotion value to the third party after processing of the payment is completed.

(4)

The information processing device according to (1), in which

the control unit controls the communication unit to

transmit, when an emotion value request is received together with a purpose of use from a third party that requests a user's emotion value, to the user that there has been an emotion value request from the third party together with the purpose of use,

transmit, when information indicating consent from the user is received, cost billing as an emotion value disclosure requirement to the user, and

return, after information indicating approval for cost payment is received from the user and processing of the payment is completed, an emotion value to the third party without substantially performing cost billing as an emotion value disclosure requirement.

(5)

The information processing device according to (4), in which

the control unit controls the communication unit to

transmit, when information indicating disapproval for cost payment for the emotion value request is received from the user, cost billing as an emotion value disclosure requirement to the third party, and

return, when information indicating consent to cost payment is received from the third party, an emotion value to the third party after processing of the payment is completed.

(6)

The information processing device according to (1), in which

the control unit controls the communication unit to

transmit, when an emotion value request is received together with a purpose of use from a third party that requests a user's emotion value, to the user that there has been an emotion value request from the third party together with the purpose of use,

notify, when information indicating consent from the user is received, the user of two options of cost billing as an emotion value disclosure requirement and payment by an emotion value, and

return, when information indicating consent to one of cost payment and payment by an emotion value is received from the user, an emotion value to the third party without substantially performing cost billing as an emotion value disclosure requirement after processing of the payment is completed.

(7)

The information processing device according to (1), in which

the control unit controls the communication unit to

notify, when an emotion value request is received together with a purpose of use from a user, the user of two options of cost billing as an emotion value disclosure requirement and payment by an emotion value, and

return, when information indicating consent to one of cost payment and payment by an emotion value is received from the user, an emotion value to the user after processing of the payment is completed.

(8)

An information processing method including, by a processor:

accumulating, in units of users in an accumulation unit, emotion values that are indices obtained by converting values of respective objects into numerical values on the basis of interaction between objects; and

controlling a communication unit to

return, when an emotion value request is received together with a purpose of use from a user via the communication unit, the user's emotion value to the user, and

transmit, when the communication unit receives an emotion value request together with a purpose of use from a third party that requests a user's emotion value, to the user that there has been an emotion value request from the third party together with the purpose of use, and transmit the user's emotion value to the third party when the communication unit receives consent from the user.

### REFERENCE SIGNS LIST

1 user terminal
2 emotion server
3 network
4 organizer terminal
10 credit database
20 control unit
201 information management unit
202 disclosure control unit
203 personal identification unit
204 disclosure cost calculation unit
21 communication unit
22 emotion value database

1. An information processing device comprising:
an accumulation unit configured to accumulate, in units of users, emotion values that are indices obtained by converting values of respective objects into numerical values on a basis of interaction between objects;
a communication unit configured to perform communication and capable of receiving an emotion value request together with a purpose of use from a user, and returning the user's emotion value to the user; and
a control unit configured to control the communication unit to
return, when an emotion value request is received together with a purpose of use from a user, the user's emotion value to the user, and
transmit, when an emotion value request is received together with a purpose of use from a third party that requests a user's emotion value, to the user that there has been an emotion value request from the third party together with the purpose of use, and transmit the user's emotion value to the third party when consent from the user is received.

2. The information processing device according to claim 1, wherein
the control unit controls the communication unit to
transmit, when an emotion value request is received together with a purpose of use from a user, cost billing as an emotion value disclosure requirement to the user, and
return, when information indicating consent to cost payment is received from the user, an emotion value to the user after processing of the payment is completed.

3. The information processing device according to claim 1, wherein
the control unit controls the communication unit to
transmit, when an emotion value request is received together with a purpose of use from a third party that requests a user's emotion value, to the user that there has been an emotion value request from the third party together with the purpose of use,
transmit, when information indicating consent from the user is received, cost billing as an emotion value disclosure requirement to the third party, and
return, when information indicating consent to cost payment is received from the third party, an emotion value to the third party after processing of the payment is completed.

4. The information processing device according to claim 1, wherein
the control unit controls the communication unit to
transmit, when an emotion value request is received together with a purpose of use from a third party that requests a user's emotion value, to the user that there has been an emotion value request from the third party together with the purpose of use,
transmit, when information indicating consent from the user is received, cost billing as an emotion value disclosure requirement to the user, and
return, after information indicating approval for cost payment is received from the user and processing of the payment is completed, an emotion value to the third party without substantially performing cost billing as an emotion value disclosure requirement.

5. The information processing device according to claim 4, wherein
the control unit controls the communication unit to
transmit, when information indicating disapproval for cost payment for the emotion value request is received from the user, cost billing as an emotion value disclosure requirement to the third party, and
return, when information indicating consent to cost payment is received from the third party, an emotion value to the third party after processing of the payment is completed.

6. The information processing device according to claim 1, wherein
the control unit controls the communication unit to
transmit, when an emotion value request is received together with a purpose of use from a third party that requests a user's emotion value, to the user that there has been an emotion value request from the third party together with the purpose of use,
notify, when information indicating consent from the user is received, the user of two options of cost billing as an emotion value disclosure requirement and payment by an emotion value, and
return, when information indicating consent to one of cost payment and payment by an emotion value is received from the user, an emotion value to the third party without substantially performing cost billing as an emotion value disclosure requirement after processing of the payment is completed.

7. The information processing device according to claim 1, wherein
the control unit controls the communication unit to
notify, when an emotion value request is received together with a purpose of use from a user, the user of two options of cost billing as an emotion value disclosure requirement and payment by an emotion value, and
return, when information indicating consent to one of cost payment and payment by an emotion value is received from the user, an emotion value to the user after processing of the payment is completed.

8. An information processing method comprising, by a processor:
accumulating, in units of users in an accumulation unit, emotion values that are indices obtained by converting values of respective objects into numerical values on a basis of interaction between objects; and
controlling a communication unit to
return, when an emotion value request is received together with a purpose of use from a user via the communication unit, the user's emotion value to the user, and
transmit, when the communication unit receives an emotion value request together with a purpose of use from a third party that requests a user's emotion value, to the user that there has been an emotion value request from the third party together with the purpose of use, and transmit the user's emotion value to the third party when the communication unit receives consent from the user.
